(19) United States
(12) Patent Application Publication
(10) Pub. No.: US 2008/0227504 A1
(43) Pub. Date: Sep. 18, 2008

(54) CERAMIC CASING DEVICE FOR MOBILE HANDSET

(76) Inventor: SHIH-YANG CHAN, Tu Cheng City (TW)

Correspondence Address: LEONG C LEI, PMB # 1008, 1867 YGNACIO VALLEY ROAD, WALNUT CREEK, CA, 94598, US

(21) Appl. No.: 11/686,357

(22) Filed: Mar. 15, 2007

(51) Int. Cl. H04M 1/00

(52) U.S. Cl. 455/575.1

(57) ABSTRACT

The chasing device contains a number of ceramic members closely pieced together into a three-dimensional form that houses the main body of a mobile handset tightly inside. The ceramic members can be adhered to the surface of the main body by adhesives or the ceramic members can be inlaid to the surface of the main body.

### TECHNICAL FIELD OF THE INVENTION

The present invention relates generally to casing devices for mobile handsets and more particularly to a casing device containing a number of ceramic members.

### DESCRIPTION OF THE PRIOR ART

Mobile handsets have become an indispensable accessory to modern urban people. As the most visually significant part, the casing of the mobile handset plays a vital role in appealing to the customers to make the purchase.

The casing of most mobile handsets is made of either plastic or metals. Plastic casing is flexible in terms of manufacturing into various shapes and colors. It is however not hard enough and scratches on the surface of the plastic casing are common. Metallic casing is heavy and less flexible. In addition, the japanning coating often peels off the surface of the metallic casing after a period of usage or under or under external impacts.

There are also a few casings that are made of ceramics. Ceramic casing is very hard yet is able to provide comparable appealing design as the plastic casing. For example, the Republic of China, Taiwan, Patent Application Serial No. 095205733, filed by the present inventor, provides a single-piece ceramic casing for mobile handsets. As the ceramic casing has to be quite thin and as the ceramic material would undergo 20%-30% contraction during sintering, the single-piece ceramic casing therefore often cracks during the manufacturing process, causing an inferior yield and high production cost.

### SUMMARY OF THE INVENTION

The primary purpose of the present invention is to provide a novel casing device to obviate the shortcomings of the prior arts.

A casing device according to the present invention contains a number of ceramic members closely pieced together into a three-dimensional form that houses the main body of a mobile handset tightly inside. The ceramic members can be adhered to the surface of the main body by adhesives or the ceramic members can be inlaid to the surface of the main body.

The ceramic members can also have different colors, textures, and/or patterns on their outer surfaces. As such, appropriate ceramic members can be manufactured, selected and combined together to deliver a unique appearance for the mobile handset and to fit the customer's particular liking.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded diagram showing the various components of a casing device according to an embodiment of the present invention.

FIG. 2 is a perspective diagram showing the casing device of FIG. 1 after it is assembled.

FIG. 3 is a front-view diagram showing the casing device of FIG. 1 after it is assembled.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

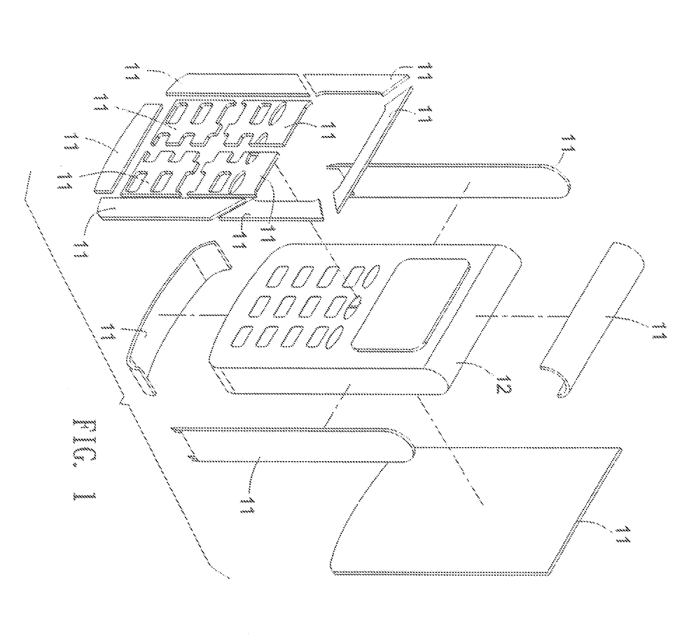

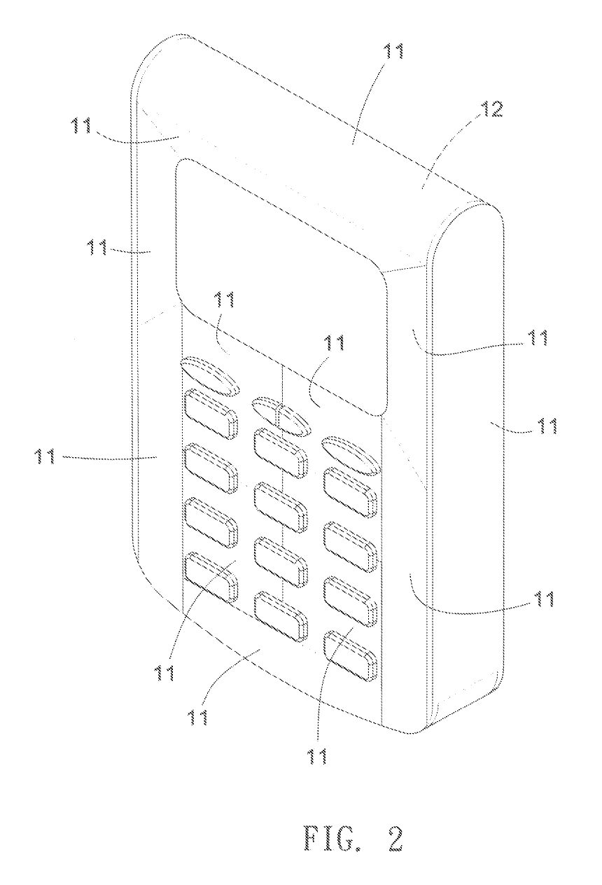

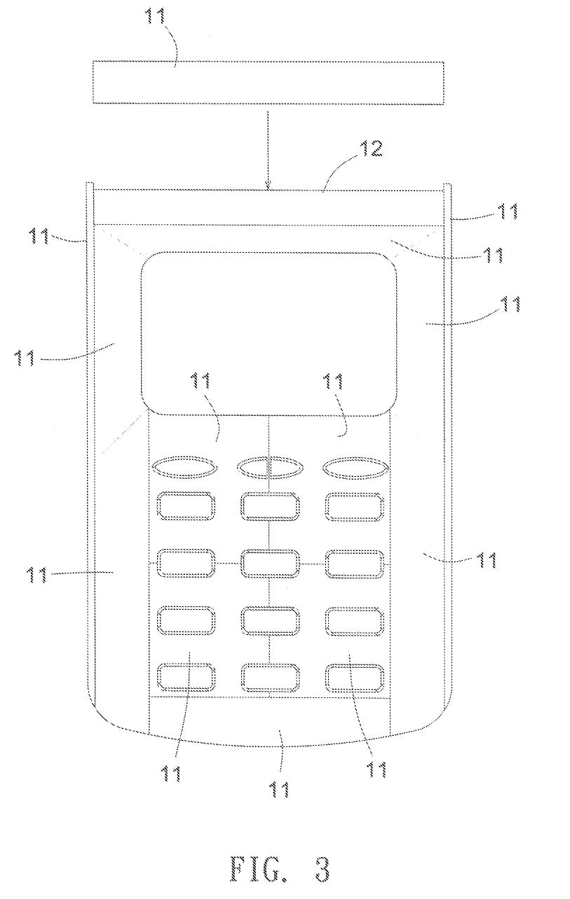

As illustrated in FIGS. 1 to 3, a casing device according to an embodiment of the present invention contains a number of ceramic members 11 closely pieced together into a three-dimensional form that houses the main body 12 of a mobile handset tightly inside. The assembled three-dimensional form of the ceramic members 11 would usually leave some openings so as to expose the screen, keypad, and other buttons of the mobile handset. The ceramic members 11 can be adhered to the surface of the main body 12 by adhesives or the ceramic members 11 can be inlaid to the surface of the main body 12.

The ceramic members 11 are not required to have specific shapes or sizes. For a mobile handset of a specific brand and model, a particular set of ceramic members 11 is designed and manufactured so as to fit on the main body 12 of the mobile handset perfectly. The ceramic members 11 can also have different colors, textures, and/or patterns on their outer surfaces. As such, appropriate ceramic members 11 can be manufactured, selected and combined together to deliver a unique appearance for the mobile handset and to fit the customer's particular liking.

As each ceramic member 11 has a reduced size compared to a single-piece casing, the manufacturing of the ceramic members 11 can have a superior yield, effectively avoiding the occurrence of cracking.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A casing device for a mobile handset, comprising a plurality of members made of a ceramic material, wherein said members are pieced together into a three-dimensional form that houses the main body of said mobile handset tightly inside.

2. The casing device according to claim 1, wherein said members are adhered to the surface of the main body of said mobile handset by adhesives.

3. The casing device according to claim 1, wherein said members are inlaid to the surface of the main body of said mobile handset.
